(19) United States
(12) Patent Application Publication
(10) Pub. No.: US 2026/0274198 A1
(43) Pub. Date: Sep. 17, 2026

(54) TENSIONING DEVICE FOR A SAFETY BELT COMPONENT

(71) Applicant: Autoliv Development AB, Vargarda (SE)

(72) Inventors: Dietmar LEGDE, Hamburg (DE); Melanie PLACZEK, Barmstedt (DE)

(21) Appl. No.: 19/167,106

(22) PCT Filed: Mar. 20, 2024
(86) PCT No.: PCT/EP2024/057411

§ 371 Date: Sep. 19, 2025

(30) Foreign Application Priority Data
Mar. 20, 2023 (DE) 102023106842.3

(51) Int. Cl. B60R 22/195

(52) U.S. Cl. CPC B60R 22/1954; B60R 22/1952

(57) ABSTRACT

The invention relates to a tensioning device for a safety belt component, having a gas generator for generating a compressed gas, a piston which is driveable by the com-pressed gas, a traction cable which is attached to the piston and is connectable to a safety belt component to be set into a tensioning movement, a tensioner tube for receiving and gniding the piston, the tensioner tube having between the gas generator and the piston a cutout in its casing, and a cable guide which projects through the cutout into the tensioner tube and with which the traction cable is led out of the tensioner tube through the cutout, the cable guide consisting of at least two, preferably precisely two parts.

The present invention relates to a tensioning device for a safety belt component, having a gas generator for generating a compressed gas, a piston which is drivable by the compressed gas, a traction cable which is attached to the piston and is connectable to a safety belt component that is to be set into a tensioning movement, and a tensioner tube for receiving and guiding the piston.

Such a tensioning device is known, for example, from DE 10 2015 111 083B4 , wherein the piston is guided in a tensioner tube. The tensioner tube is connected to a deflection block produced by die casting, which forms a cable deflection means for the traction cable and forms a receptacle for the gas generator and a pressure chamber into which the compressed gas produced by the gas generator flows. The use of the deflection block connected to the end face of the tensioner tube requires a component which is relatively expensive to produce and which also requires a relatively large amount of space.

WO 2021/160 569 A1 therefore discloses a tensioning device in which the gas generator is arranged within the rectilinear tensioner tube. A cutout is formed in the casing of the tensioner tube, through which the traction cable is guided out of the tensioner tube. In order to guide the traction cable out of the tensioner tube, a cable deflection means is disclosed which is designed in several parts, wherein a component referred to as the guide part having a receptacle for the gas generator can be inserted into the tensioner tube and a component referred to as the fixing part projects through the cutout from the outside such that the traction cable is guided through the cutout by means of the fixing part, also referred to below as the cable guide.

According to WO 2021/160 569A1 , the cable guide referred to as the fixing part is formed in one piece. To assemble the tensioning device, one end, facing away from the safety belt component, of the traction cable is first threaded through the one-piece cable guide, then inserted through the cutout and into the guide part and into the tensioner tube. The traction cable is then pulled beyond the end of the tensioner tube, wherein the piston and the fastening means are then attached to the traction cable, and wherein the fastening means is then pressed with the traction cable. The end of the traction cable associated with the safety belt component is then pulled so that the piston and the fastening means return to their original position. Since the end associated with the safety belt component comes into contact with the cable guide threaded onto the traction cable during assembly, the length to which the traction cable can be pulled out of the tensioner tube in order to press the fastening means thereon is limited. However, this therefore also limits the tensioning path.

The object addressed by the present invention is therefore that of eliminating at least some of the disadvantages described with respect to the prior art and, in particular, providing a tensioning device and a method for producing a tensioning device, which allow for a longer tensioning path.

The object is achieved in particular by a method for producing a tensioning device, involving the following steps in the order specified:
a) providing an in particular rectilinear tensioner tube having a cutout in the casing thereof,
b) inserting a traction cable into the tensioner tube, wherein the traction cable is guided through the cutout, in particular from the outside, and into the tensioner tube,
c) fastening a fastening means to the traction cable, e.g., by pressing the fastening means with the traction cable,
d) attaching a multipart cable guide to the traction cable on a portion, projecting beyond the cutout, of the traction cable, wherein regions of the traction cable are surrounded by the multipart cable guide,
e) inserting the cable guide into the cutout.

In other words, the method analogously provides that the traction cable first be introduced into the tensioner tube via the cutout, wherein the element which transmits the force from the piston to the traction cable during actuation (i.e., the fastening means) is then first fixed to the traction cable, wherein only then is the cable guide attached to a portion, outside the tensioner tube, of the traction cable, which portion is formed between the cutout and the end associated with the safety belt component. For this purpose, the cable guide is designed in several parts so that the traction cable does not have to be threaded through the cable guide before being introduced into the tensioner tube. This therefore means that a larger tensioning path is possible even with otherwise identical dimensions.

In particular, it is also proposed that, before step b), a guide part be inserted into the tensioner tube from one end face, wherein a gas generator is preferably pre-assembled in the guide part, and, in step e), the cable guide is brought into engagement with the guide part.

Accordingly, the object is also achieved by a tensioning device having the features mentioned at the outset, in which the tensioner tube has a cutout in its casing between the gas generator and the piston, and in which a cable guide is provided which projects through the cutout into the tensioner tube and with which the traction cable is guided out of the tensioner tube via the cutout, wherein it is provided that the cable guide consist of at least two, preferably exactly two, parts.

In other words, the invention proposes that the cable guide, i.e., the component of the tensioning device with which the traction cable is guided through the cutout and into the tensioner tube, be designed in several parts, wherein the parts of the cable guide are arranged and designed such that they surround the traction cable in its circumferential direction when assembled with one another, and therefore the cable guide can be attached to the traction cable, and the traction cable does not have to be threaded through an opening through the cable guide. The (cutting) planes at which or along which the parts of the cable guide rest against one another thus extend (at least virtually) into the region of an opening through which the traction cable extends when the cable guide is assembled. It is thus possible to attach the cable guide to the traction cable after the traction cable has been inserted into the tensioner tube with a free through the cutout. This makes it possible to attach the cable guide to the traction cable at a later point in the manufacturing process, which in turn allows for a greater tensioning path with otherwise identical dimensions.

The parts of the cable guide are in particular also designed in such a way that the traction cable can come into contact with the parts of the cable guide when assembled.

In one embodiment, it can be provided that the at least two, preferably exactly two, parts rest against one another along a plane that runs in parallel with a longitudinal axis of the tensioner tube. Alternatively or additionally, it can be provided that the at least two parts rest against one another along a plane which extends transversely, in particular orthogonally, to a longitudinal axis of the tensioner tube.

In both cases, the two parts of the cable guide can be fastened to the traction cable from opposite directions.

In one embodiment, it can be provided that the second part be/will be arranged between two portions of the first part. In this case, it is possible to insert the traction cable between the two portions of the first part and then to slide the second part between the two portions, wherein the second part to be fastened to one another by suitable means, e.g., by a bolt extending through the two portions of the first part and through the second part. In this case, the two parts are fixed to one another or immovably fixed to one another by an additional element.

In an alternative embodiment, however, it can also be provided that the two parts be fixed to one another in a form-fitting and/or force-fitting manner, preferably exclusively in a form-fitting manner. For this purpose, the two parts can have complementary designs, with projections and recesses that interlock for securing them. For example, hook-shaped, elastically deflectable elements can be formed on one part, which engage in corresponding cutouts in the other part.

In order to further simplify the manufacturing process and avoid mixing up components, it can also be provided that the two parts of the cable guide be connected to one another via a living hinge so that the two parts can be folded toward one another for attachment to the traction cable.

It can also be provided that a portion of the first part extend along the second part only on one side. In this connection, it can be provided in particular that the same second part be able to be used for different first parts, wherein the two first parts differ from one another in that the portions extending along the second part are arranged on opposite sides of the second part. Depending upon the installation situation of the tensioning device later on, either the first or second alternative of the first part can then be used, while the second part is identical in construction.

The invention relates in particular to tensioning devices in which the tensioner tube has a cutout in its casing between the gas generator and the piston and in which the tensioning device comprises a cable guide which projects through the cutout and into the tensioner tube and with which the traction cable is guided through the cutout. This means that the die-cast deflection block is no longer required.

It is particularly provided that the cable guide engage in the guide part by the cable guide's portion that engages in the tensioner tube, whereby, on the one hand, the guide part is fixed in position in the tensioner tube and, on the other, the traction cable can pass through the cutout without the traction cable coming into contact with an edge of the cutout formed by the tensioner tube.

The gas generator is arranged in particular within the tensioner tube, wherein it can preferably be provided that the guide part have a receptacle, wherein the gas generator is arranged in the receptacle. In this connection, it is particularly provided that the guide part be designed such that the compressed gas generated by the gas generator is guided along the traction cable inside the tensioner tube to the piston without the compressed gas acting upon the traction cable in the region of the guide part.

The cutout for the traction cable and the cable guide is arranged in particular in a rectilinear portion of the tensioner tube, wherein it is in particular provided that the tensioner tube be rectilinear over its entire extent.

The invention and the technical environment are explained below by way of example with reference to the figures. Schematically, in the figures:

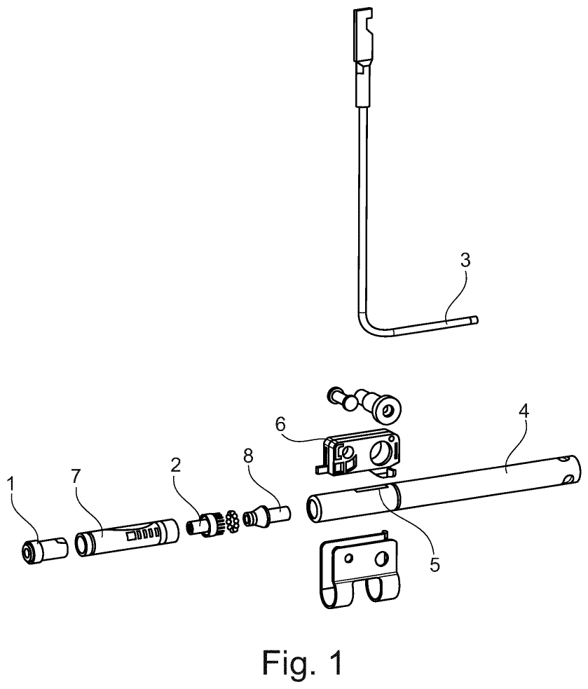

FIG. 1 is an exploded view of a tensioning device,

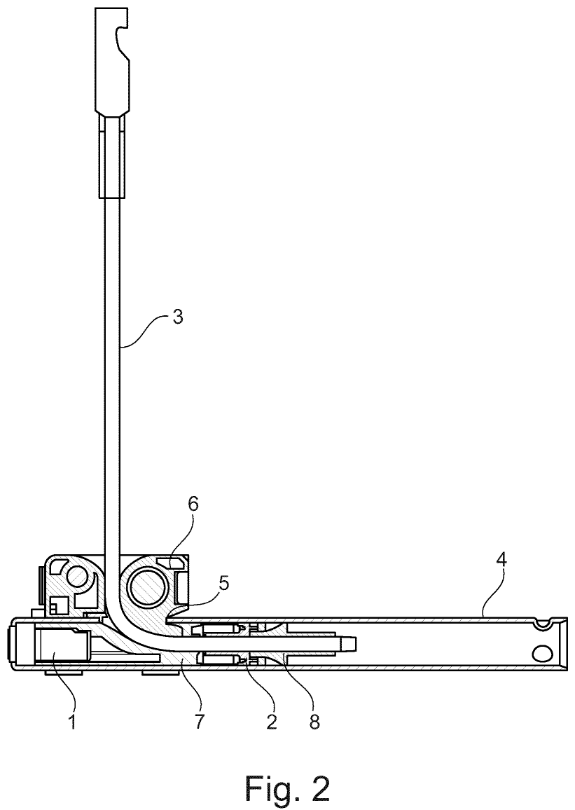

FIG. 2 is a sectional view along the longitudinal axis of a tensioner tube through the tensioning device, and

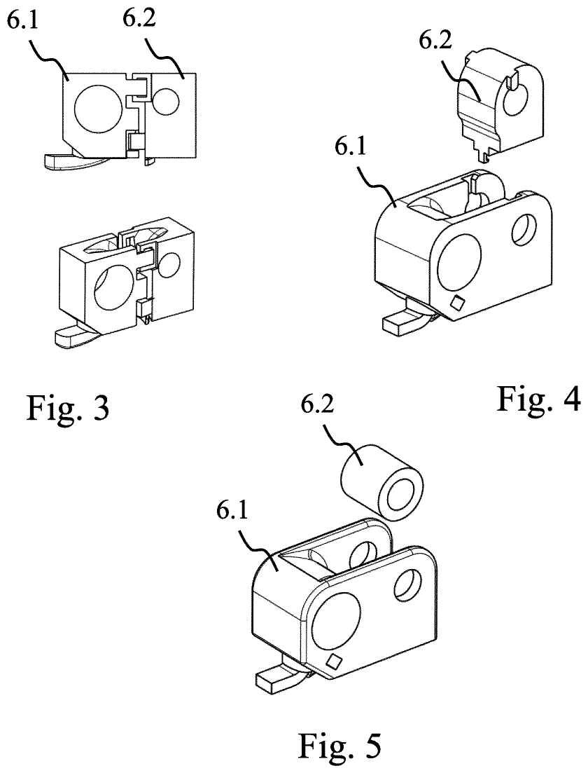

FIGS. 3 to 10 show various embodiments of the multipart cable guide.

The tensioning device shown in FIGS. 1 and 2 comprises a tensioner tube 4 and a traction cable 3 for a safety belt component. A cutout 5 is formed in the tensioner tube 4, through which the traction cable 3 is guided by means of a cable guide 6. Within the tensioner tube 4, a piston 2 is arranged on the traction cable 3, wherein a fastening means 8 is pressed with the traction cable 3 and rests against the piston 2. Within the tensioner tube 4, there is also a guide part 7 which forms a receptacle for a gas generator 1. In the assembled state, the gas generator 1 is therefore also arranged in the tensioner tube 4.

As can be seen in particular from FIG. 2, the cable guide 6 engages in the guide part 7 in the assembled state, wherein the traction cable 3 is guided through the guide part 7. The cable guide 6 is fixed by means of a clamp 10 surrounding the tensioner tube 4, for which purpose bolts 11 are provided which pass through the cable guide 6 and the clamp 10.

During actuation, the gas generator 1 generates a compressed gas which is guided through the guide part 7 along the traction cable 3 and to the piston 2 without coming into contact with the traction cable 3. As a result of the compressed gas, the piston 2 is driven (to the right in FIG. 2), wherein the piston 2 at its end facing away from the gas generator 1 rests on the fastening means 8. The tensioning device can therefore be used to retract a safety belt component (such as an end fitting or belt buckle) that can be connected to the traction cable 3.

As will be explained below with reference to the exemplary embodiments in FIGS. 3 to 10, the cable guide 6 is designed in several parts, which makes it possible for the cable guide 6 to be attached to the traction cable 3 after the end of the traction cable 3, which is connected to the fastening means 8 later on, has already been introduced into the tensioner tube 4 via the cutout 5. However, in order to attach the fastening means 8, it is thus also possible for the traction cable 3 to be pulled somewhat further out of the tensioner tube 4 through the right-hand end shown in FIG. 2 than if the cable guide were already threaded onto the traction cable 3, as would be necessary with a one-piece design of the cable guide.

The cable guide 6 in particular comprises a first part 6.1 and a second part 6.2. The first part 6.1 and the second part 6.2 can each have at least one through-opening through which a bolt 11 for fixing the parts 6.1 and 6.2 to the tensioner tube 4 can be guided.

According to the embodiment in FIG. 3, the first part 6.1 and the second part 6.2 are separated from one another along a plane that runs orthogonally to a longitudinal axis of the tensioner tube 4. The parts 6.1 and 6.2 each have a through-opening through which a bolt 11 can be pushed in order to fasten the cable guide 6 to the tensioner tube 4 and to the clamp 10. The first part 6.1 is fixed to the second part 6.2 by means of a snap connection, for which the parts 6.1 and 6.2 have corresponding hooks and recesses.

According to the exemplary embodiments in FIGS. 4 and 5, the first parts 6.1 each have two parallel portions between which the second part 6.2 is arranged, wherein the second part 6.2 has a through-opening which, in the assembled state, is aligned with through-openings in the parallel portions of the first part 6.1 such that a bolt can be passed through the through-openings. To assemble the cable guide 6, the first part 6.1 is first placed on the traction cable 3, wherein, then, the second part 6.2 is placed between the parallel portions of the first part 6.1 and there fixed in position.

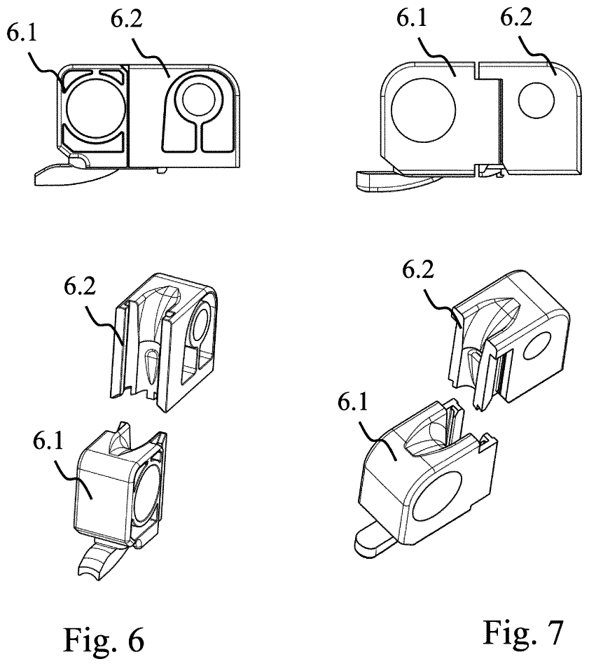

According to the exemplary embodiments in FIGS. 6 and 7, the first part 6.1 and the second part 6.2 have corresponding form-locking configurations such that the two parts 6.1 and 6.2 can be connected to one another by sliding the form-locking configurations into one another, wherein the movement direction runs in parallel with the traction cable 3 arranged between the parts.

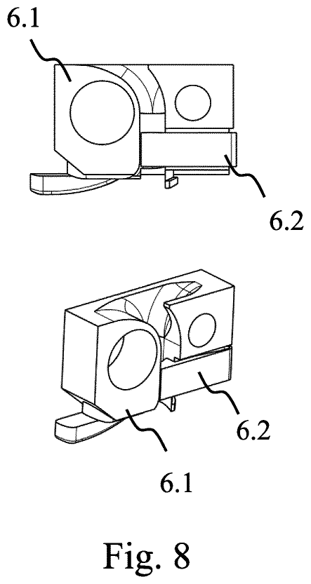

According to the exemplary embodiment in FIG. 8, the first part 6.1 has a lateral recess through which the first part 6.1 can be placed on the traction cable 3. The lateral recess can then be closed again by attaching the second part 6.2 so that the traction cable 3 is guided through in the cable guide 6 consisting of the two parts 6.1 and 6.2.

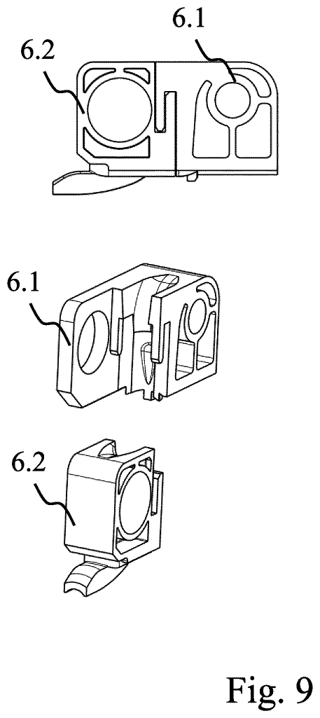

According to the exemplary embodiment in FIG. 9, one portion of the first part 6.1 extends along one side of the second part 6.2, wherein a through-opening in the portion extending along the second part 6.2 is aligned with a through-opening in the second part 6.2. The second part 6.2 can also be used with a first part 6.1, in which the portion extending in parallel along the second part 6.2 is arranged on the opposite side. Thus, the second part 6.2 can be used with different first parts 6.1 depending upon the installation situation of the tensioning device.

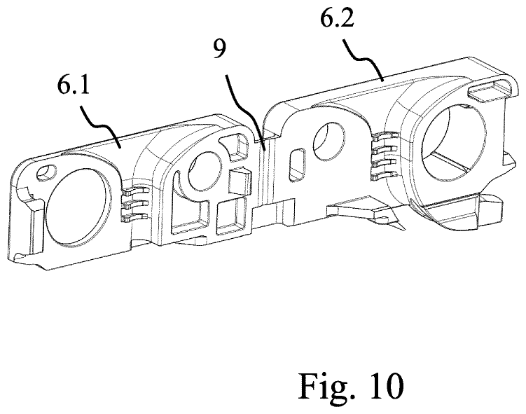

According to the embodiment in FIG. 10, the first part 6.1 and the second part 6.2 are connected to one another via a living hinge 9. The first part 6.1 and the second part 6.2 can thus be folded onto one another, wherein the traction cable 3 is arranged between the parts 6.1 and 6.2. This has the advantage that the two parts 6.1 and 6.2 are already captively connected to one another before assembly, making the assembly process more reliable.

### List of Reference Signs

1 Gas generator
2 Piston
3 Traction cable
4 Tensioner tube
5 Cutout
6 Cable guide
6.1 First part
6.2 Second part
7 Guide part
8 Fastening means
9 Living hinge
10 Clamp
11 Bolt

1. Tensioning device for a safety belt component, having
a gas generator for generating a pressurized gas,
a piston that can be driven by the pressurized gas,
a traction cable which is connected to the piston and which can be connected to a safety belt component that is to be set into a tensioning movement,
a tensioner tube for receiving and guiding the piston, wherein the tensioner tube has a cutout in its casing between the gas generator and the piston, and
a cable guide which projects through the cutout into the tensioner tube and with which the traction cable is guided out of the tensioner tube through the cutout, wherein
the cable guide consists of at least two, preferably exactly two, parts.

2. Tensioning device according to claim 1, wherein the at least two parts are designed such that the at least two parts surround the traction cable in its circumferential direction in a mounted state.

3. Tensioning device according to claim 1, wherein the traction cable can be brought into contact with the at least two parts.

4. Tensioning device according to claim 1, wherein the at least two parts rest against each other along a plane extending in parallel with a longitudinal axis of the tensioner tube.

5. Tensioning device according to claim 1, wherein the second part is arranged between two portions of the first part.

6. Tensioning device according to claim 1, wherein the at least two parts rest against each another along a plane which extends transversely, in particular orthogonally, to a longitudinal axis of the tensioner tube.

7. Tensioning device according to claim 1, wherein the at least two parts rest against each other along a first plane extending in parallel with a longitudinal axis of the tensioner tube and along a second plane extending orthogonally to a longitudinal axis of the tensioner tube.

8. Tensioning device according to claim 1, wherein a portion of the first part extends on only one side along the second part.

9. Tensioning device according to claim 1, wherein the at least two parts are interlockingly and/or frictionally fixed to one another.

10. Tensioning device according to claim 1, wherein two parts of the cable guide are connected to one another via a living hinge.

11. Method for producing a tensioning device, comprising the following steps in the specified order:
a) providing an in particular rectilinear tensioner tube having a cutout in its casing,
b) introducing a traction cable into the tensioner tube, wherein the traction cable is guided through the cutout,
c) fastening a fastening means to the traction cable,
d) attaching a multipart cable guide to the traction cable outside the tensioner tube on a portion, projecting beyond the cutout, of the traction cable, wherein the traction cable is surrounded in portions by the cable guide,
e) inserting the cable guide into the cutout.

12. Method according to claim 11, wherein, before step b), a guide part is inserted from one end face into the tensioner tube, wherein a gas generator is preferably pre-assembled in the guide part, wherein, in step e), the cable guide is brought into engagement with the guide part.
